(19) United States
(12) Patent Application Publication
(10) Pub. No.: US 2013/0191035 A1
(43) Pub. Date: Jul. 25, 2013

(54) METHOD AND SYSTEM FOR DETECTION AND REJECTION OF MOTION/NOISE ARTIFACTS IN PHYSIOLOGICAL MEASUREMENTS

(71) Applicants: Ki H. Chon, Worcester, MA (US); Nandakumar Selvaraj, Worcester, MA (US)

(72) Inventors: Ki H. Chon, Worcester, MA (US); Nandakumar Selvaraj, Worcester, MA (US)

(21) Appl. No.: 13/822,750

(22) PCT Filed: Oct. 12, 2011
(86) PCT No.: PCT/US2011/055966

§ 371 Date: Mar. 13, 2013

Related U.S. Application Data
(60) Provisional application No. 61/392,292, filed on Oct. 12, 2010.
(60) Provisional application No. 61/434,862, filed on Jan. 21, 2011.

(51) Int. Cl. G06F 19/00

(52) U.S. Cl. CPC G06F 19/34
USPC 702/19

(57) ABSTRACT

Methods and systems for quantitatively detecting the presence of artifacts in physiological measurement data and for determining usable data among those that have been designated to be corrupted with artifacts are presented.

### BACKGROUND

The pulse oximeter is one of the most widely used noninvasive sensors because it offers comfortable probe attachment to the patient and is easy to operate. The pulse oximeter waveform, otherwise known as the Photoplethysmogram (PPG), is comprised of abundant vital physiological information that can be useful for diagnostic as well as prognostic applications. Therefore, there is growing interest in the real-time, wearable and ambulatory monitoring of vital signs using a PPG sensor. However, motion and noise artifacts (hereafter simply referred to as artifacts) are a serious obstacle in realizing this quest. Artifacts have been recognized as an intrinsic weakness of using the PPG signal that limits its practical implementation and reliability for real-time monitoring applications. Artifacts are the most common cause of false alarms, loss of signal, and inaccurate measurements in clinical monitoring, where artifacts are more likely due to the voluntary and involuntary movements of the patient.

While the intelligent design of hardware elements such as PPG sensor attachment, form factor, and packaging can help to reduce the impact of motion disturbances by making sure that the sensor is securely mounted, it is rarely sufficient to entirely avert artifacts. Various algorithms have also been attempted to isolate the effects of undesired artifacts with the outcomes being less than desired. One of the prime culprits for these shortcomings is that when the noise falls within the same in-band frequency of the physiological signal of interest, the conventional linear signal filtering with fixed cut-off frequencies turns out to be ineffective. Among the numerous signal processing techniques explored to address the confounding issue of “in-band” noise, one of the most appealing digital filtering methods is adaptive noise cancellation (ANC). Accelerometers (ACC) combined with ANC have previously been suggested as a promising approach for active noise cancellation of motion-corrupted PPG waveforms. However, this approach has numerous shortfalls such as the increased hardware complexity and its dependency on the type of artifact. For example, noise cancellation is inadequate for less repetitive artifacts.

Any artifact removal technique would first require an automated approach to accurately detect the artifacts. An algorithm based on the comparison between the heart rate (HR) measured from an ECG and HR calculated from PPG-obtained pulse rate for very short segments has been reported for reliable artifact detection in PPG signals. This approach is not very efficient and practical, since it requires the additional recording of the ECG to achieve artifact detection in the PPG signal. Statistical measures on just the PPG signal such as skewness, kurtosis, Shannon entropy and Renyi's entropy have been shown useful for automatic detection of artifacts (these measures have also been applied to electroencephelogram signals). However, no detailed quantitative results have been reported to verify their accuracy and suitability for successful detection of artifacts in PPG waveforms. Hence, a comprehensive and quantitative approach is needed to accurately and automatically detect the presence of artifacts in PPG data. In addition, the quantitative assessment of the severity of noise is another challenge because some of the corrupted data can be utilized for detection of HR or blood loss, provided that the artifacts are not so significant.

The motion artifact has been recognized as the intrinsic weakness of PPG signal and as a serious obstacle to reliable use of PPG for real-time and continuous monitoring applications. The motion artifacts are more likely in clinical situations where the patient is awake due to voluntary or involuntary movements of the patient which obviously limit the practical accuracy of PPG technique and hence a robust computational technique is warranted that can be used to accurately detect the motion artifacts and assess the severity of noise.

### BRIEF SUMMARY

Embodiments of methods and systems for quantitatively detecting the presence of artifacts in physiological measurement data and for determining usable data among those that have been designated to be corrupted with artifacts are presented below.

One embodiment of the method of these teachings for detection and amelioration of the effects of motion/noise artifacts in physiological measurement includes preprocessing a segment of a signal from a physiological measurement, obtaining a value of one or more indicators of volatility for the preprocessed segment, determining from comparison of the value of the one or more indicators of volatility with a predetermined threshold whether or not noise/motion artifacts are not present. If noise/motion artifacts are not present, the segment is included in calculations quantities of interest and the method proceeds to another segment, if another segment is available. If noise/motion artifacts are present, a time-frequency spectrum analysis is performed for the preprocessed segment and a predetermined measure of the time-frequency spectrum analysis is compared to a predetermined measure's threshold. If the predetermined measure is within limits determined by the predetermined measure's threshold, the segment is included in calculations quantities of interest and the method proceeds to another segment, if another segment is available. If the predetermined measure is not within the limits determined by the predetermined measure's threshold, the segment is discarded and the method proceeds to another segment, if another segment is available.

In one embodiment of the system of these teachings, the system includes one or more processors and computer usable media having computer readable code embodied therein for causing the one or more processors to implement embodiments of the method of these teachings.

A number of other embodiments are also disclosed as well as embodiments of computer program products including computer usable media having computer readable code embodied therein for causing one or more processors to implement embodiments of the method of these teachings.

For a better understanding of the present teachings, together with other and further needs thereof, reference is made to the accompanying drawings and detailed description and its scope will be pointed out in the appended claims.

### BRIEF DESCRIPTION OF THE DRAWINGS

FIGS. 1 and 1a are schematic flowchart representations of embodiments of the method of these teachings; FIG. 1 is an exemplary embodiment of the method shown in FIG. 1 where the physiological measurement is a waveform obtained from a pulse oximeter.

FIG. 2 is a schematic block diagram representation of an embodiment of the system of these teachings;

FIG. 3 is Representative finger PPG signal recorded during protocol used for bi-spectrum coupling measurements;

FIGS. 4a-f are Finger-PPG signal, its PSD and the identified statistically significant phase coupled peak for bi-spectrum coupling measurements);

FIGS. 5a-5l show Sample clean (a-d) and corrupted (e-f) ear-PPG segments applied with 1st-order (a, c, e) and 32^{nd} order polynomial detrends (b, d, f) are shown along with their respective histograms and calculated kurtosis (K) and Shannon entropy (SE) values from results for one embodiment of these teachings;

FIG. 6a-6f show the SE values (left panel) obtained for clean and corrupted PPG segments of ear (1^{st} row), finger (2^{nd} row) and forehead (3^{rd} row) PPG probe sites from results for one embodiment of these teachings;

FIG. 7a-7f show the kurtosis values (left panel) obtained for clean and corrupted PPG segments of ear (1^{st} row), finger (2^{nd} row) and forehead (3^{rd} row) PPG probe sites from results for one embodiment of these teachings;

FIG. 8 shows Sample forehead-PPG signals are given along with the kurtosis and SE values computed for each segment from results for one embodiment of these teachings;

FIG. 9 shows a representative clean finger-PPG signal recorded during voluntary introduction of artifacts from results for one embodiment of these teachings;

FIG. 10a-10d show values of (a) SE and (b) kurtosis measures obtained for clean and corrupted finger-PPG segments and the specificity (Sp) and sensitivity (Se) analysis for (c) SE and (d) kurtosis measures from results for one embodiment of these teachings; and

FIGS. 11a-11f show representative (a) usable and (d) not usable finger PPG data from results for one embodiment of these teachings.

### DETAILED DESCRIPTION

The following detailed description is of the best currently contemplated modes of carrying out these teachings. The description is not to be taken in a limiting sense, but is made merely for the purpose of illustrating the general principles of these teachings, since the scope of these teachings is best defined by the appended claims. Although the teachings have been described with respect to various embodiments, it should be realized these teachings are also capable of a wide variety of further and other embodiments within the spirit and scope of the appended claims.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.”

To assist in the understanding of the present teachings the following definitions are presented.

“Volatility,” as used herein, refers to a measure of the probability of obtaining an extreme value in the future, such as measured by kurtosis and other statistical measures.

“Detrending,” as used herein, refers to the process of finding a best polynomial fit to a time series and subtracting that best polynomial fit from the time series.

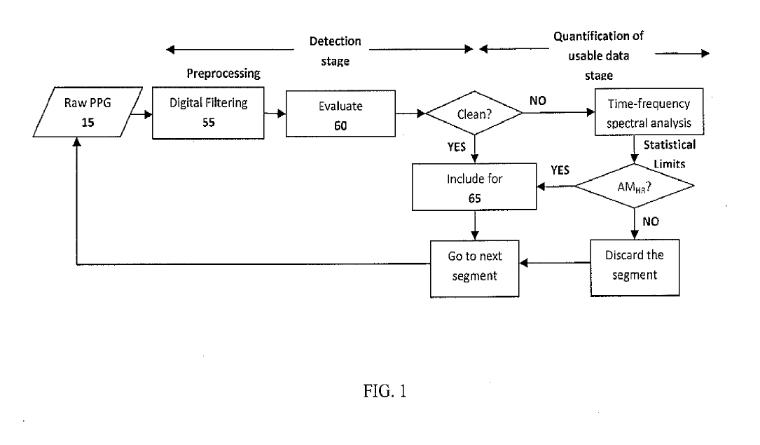

In one embodiment of the method of these teachings for detection and amelioration of the effects of motion/noise artifacts in physiological measurement, shown in FIG. 1a, the method includes preprocessing a segment of a signal (15, FIG. 1a) from a physiological measurement (20, FIG. 1a), obtaining a value of one or more indicators of volatility for the preprocessed segment (25, FIG. 1a) and determining from comparison of the value of the one or more indicators of volatility with a predetermined threshold whether or not noise/motion artifacts are not present. If noise/motion artifacts are not present, the segment is included in calculations quantities of interest (40, FIG. 1a) and the method proceeds to another segment (50, FIG. 1a), if another segment is available. If noise/motion artifacts are present, a time-frequency spectrum analysis is performed for the preprocessed segment (30, FIG. 1a) and a predetermined measure of the time-frequency spectrum analysis is compared to a predetermined measure's threshold (35, FIG. 1a). If the predetermined measure is within limits determined by the predetermined measure's threshold, the segment is included in calculations quantities of interest (40, FIG. 1a) and the method proceeds to another segment, if another segment is available (50, FIG. 1a). If the predetermined measure is not within the limits determined by the predetermined measure's threshold, the segment is discarded (45, FIG. 1a) and the method proceeds to another segment (50, FIG. 1a), if another segment is available.

In one instance, the measure of volatility used in the above disclosed embodiment includes kurtosis. In another instance, the measure of volatility includes Shannon entropy. In a further instance, the measure of volatility uses both kurtosis and Shannon entropy.

In one exemplary instance of the above disclosed embodiment of the method of these teachings, physiological measurement is a pulse oximeter waveform, referred to as a Photoplethysmogram (PPG). In that instance or exemplary embodiment, the measure of volatility can also include a quadratic phase coupling between a fundamental heart rate frequency and a first harmonic of the fundamental heart rate frequency in addition to kurtosis and Shannon entropy. These three measures of volatility can be used independently, can be combining groups of two, or all three can be used together employing concepts of data fusion.

When the measure of volatility is either kurtosis or Shannon entropy, the threshold against which kurtosis or Shannon entropy are compared to in order to determine whether noise/motion artifacts are present is determined, in one instance, not a limitation of these teachings, using receiver operator characteristic (ROC) analysis.

In one instance, the time-frequency spectrum analysis is performed using a variable frequency complex demodulation method. When the physiological measurement is a pulse oximeter waveform, referred to as a Photoplethysmogram (PPG),

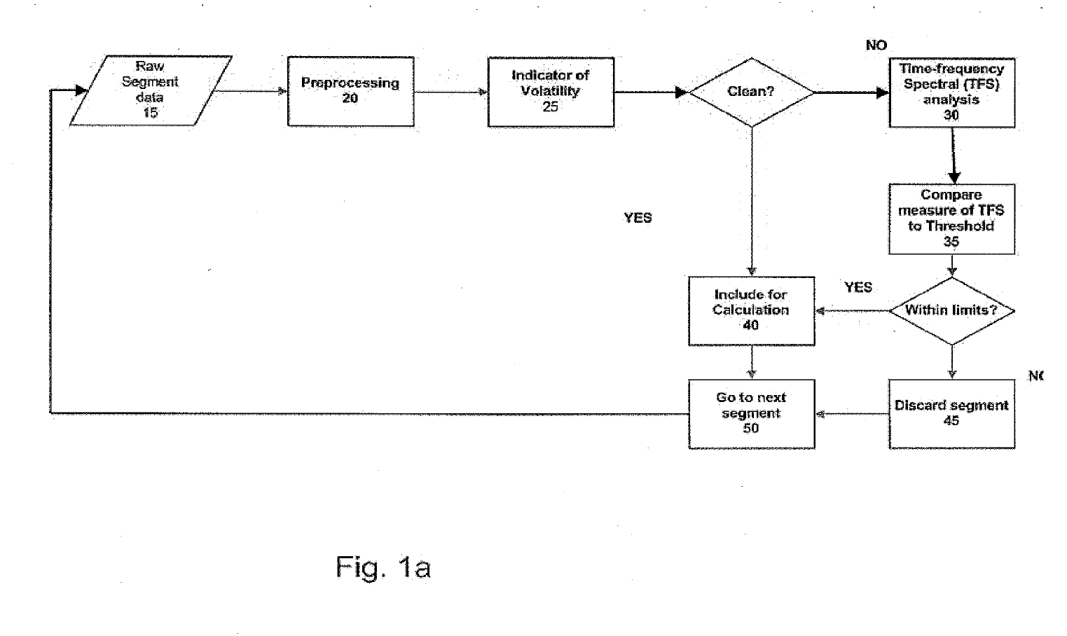

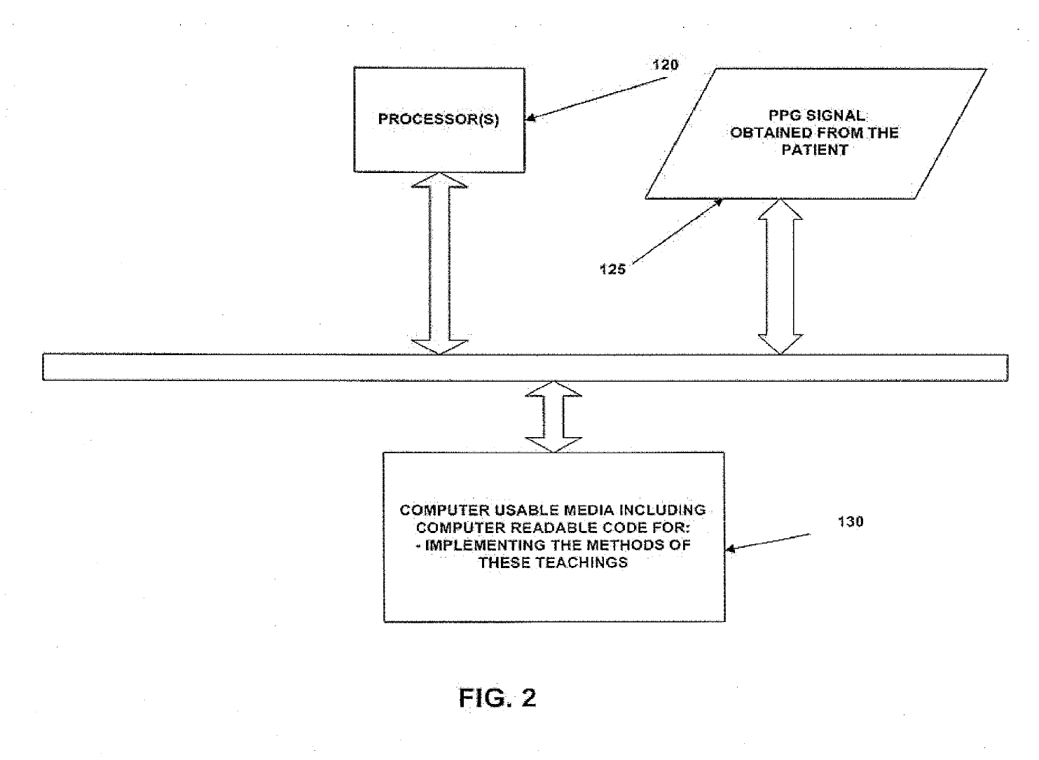

In one embodiment of the system of these teachings, shown in FIG. 2, the system includes one or more processors 120 and one or more computer usable media 130 that has computer readable code embodied therein, the computer readable code causing the one or more processors to execute at least a portion of the method of these teachings. The system also receives the PPG signal obtained from the patient 125. The one or more processors 120, the one or more computer usable media 130 and the data from the PPG signal are operatively connected.

An exemplary embodiment is described herein below. However it should be noted that these teachings are not limited to only that exemplary embodiments.

Experimental protocol for one exemplary embodiment We tested our algorithm on PPG signals obtained from two distinct scenarios as follows.

1. Involuntary movements: Multi-site PPG signals recorded from 10 healthy volunteers under supine resting conditions for 5 to 20 minutes in clinical settings were used for our analysis. The data analyzed were a part of simulated blood loss experiments which consisted of baseline and lower body negative pressure application where the data from only the former condition was used for this study. Three identical reflective infrared PPG-probes (MLT1020; ADI Instruments, CO Springs, Colo., USA) were placed at the finger, forehead and ear. While the finger and ear PPG probes were attached with a clip, the forehead probe was securely covered by a clear dressing. The PPG signals were recorded at 100 Hz with a Powerlab/16SPdata acquisition system equipped with a Quad Bridge Amp (ML795 & ML112; ADI Instruments) and a high-pass filter cut-off of 0.01 Hz. The subjects were not restricted from making any sort of movements during the recording procedure.

2. Voluntary movements: Finger-PPG signals were obtained from 14 healthy volunteers in an upright sitting posture using an infrared reflection type PPG transducer (TSD200) and a biopotential amplifier (PPG100) with a gain of 100 and cut-off frequencies of 0.05-10 Hz. The MP100 (BIOPAC Systems Inc., CA, USA) was used to acquire finger PPG signals at 100 Hz. After baseline recording for 5 minutes without any movements (i.e. clean data), motion artifacts were induced in the PPG data by left-right movements of the index finger with the pulse oximeter on it. The subjects were directed to produce the motions for time intervals that determined the percentage of noise within each 1 minute segment, varying from 10 to 50%. For example, if a subject was instructed to make left-right movements for 6 seconds, that segment of data would contain 10% noise. Such controlled movements were carried out 5 times for each level of noise. In this protocol, we used the left-right movement of the index finger having the PPG clamp to induce movement artifacts since left-right movement was perpendicular to the plane of the PPG sensor orientation and thus generated significant noise as compared to up-down or arbitrary movements of the finger. The recorded PPG signals from both protocols were analyzed offline using Matlab®.

B. Data Preprocessing:

The PPG data were partitioned into 60s segments and shifted every 10s for the entire data. Each 60s PPG segment was subjected to a finite impulse response (FIR) band pass filter of order 64 with cut-off frequencies of 0.1 Hz and 10 Hz. To account for the time-dependent low-frequency trends associated with the PPG signal and depending on the type of data analysis, either a low- or high-order polynomial detrending was used. For the purpose of artifact detection, we used in some cases as high as the 32′-order polynomial fit to eliminate nonstationary dynamics in the PPG signal. The use of a high-order polynomial detrend is the key to an effective classification between clean and artifact-containing signals, which will be demonstrated in the Results Section. For the time-frequency-spectral analysis during the second stage to determine usable data, a standard 2^{nd} order polynomial detrend was used on the original PPG data (not on the data with a high-order polynomial detrend). Following detrend with either a low- or high-order polynomial fit, the PPG signal was zero-meaned. Before we conducted our computational analysis, we visually examined the PPG waveforms in each data segment and classified them into clean vs. corrupted segments. Any sort of disruption in the pulse characteristics was labeled as corrupted segments. This was done in order to later determine the accuracy of the method.

C. Computational Measures for Artifact Detection

Following the preprocessing of each PPG data segment, our approach for the detection of artifacts involves the computation of the following two parameters.

1. Kurtosis: Kurtosis is a statistical measure used to describe the distribution of observed data around the mean. It represents a heavy tail and peakedness or a light tail and flatness of a distribution relative to the normal distribution. The kurtosis of a normal distribution is 3. Distributions that are more outlier-prone than the normal distribution have kurtosis greater than 3; distributions that are less outlier-prone have kurtosis less than 3. The kurtosis is defined as:

$$k = \frac{{E ( x - μ )}^{4}}{{σ}^{4}} \qquad ( 1 )$$

Where μ is the mean of x, σ is the standard deviation of x, and E(t) represents the expected value of the quantity t.

2. Shannon entropy: SE quantifies how much the probability density function (PDF) of the signal is different from a uniform distribution and thus provides a quantitative measure of the uncertainty present in the signal [14]. SE can be calculated as

$$SE = - {\sum }_{i = 1}^{k} \frac{p ( i ) * log ( p ( i ) )}{log ( \frac{1}{k} )} \qquad ( 2 )$$

Where i represents the bin number, and p(i) is the probability distribution of the signal amplitude. Presently, 16 bins (k=16) have been used to obtain a reasonably accurate measure of SE [15].

D. Statistical Analysis of Computational Measures:

The nonparametric Mann Whitney test was conducted on data from the involuntary motion protocol to find the significance levels (p<0.05) for the SE and kurtosis measures between clean vs. corrupted PPG segments. Meanwhile, the nonparametric Kruskal-Wallis test with Dunn's multiple comparison post test was conducted on data from the voluntary motion protocol to find the significance (p<0.05) between clean vs. noise-corrupted PPG segments for the two measures.

E. Detection of Motion/Noise Artifacts:

By varying kurtosis values from 0 to 10 with an increment of 0.1, and SE values from 0.5 to 1.0 with an increment of 0.01, receiver-operator characteristic (ROC) analysis were conducted for the population of SE and kurtosis values obtained from the respective pool of clean and corrupted PPG segments of both protocols. The substantially optimal threshold values for kurtosis and SE that produced the substantially optimal sensitivity and specificity for the detection of artifacts. (see, for example, S. H. Park et. al., Receiver Operating Characteristic (ROC) Curve: Practical Review for Radiologists, Korean J. Radiol. 2004 January-March; 5(1): 11-18, which is Incorporated by reference herein is entirety for all purposes) where evaluated.

The decision rules for the detection of artifacts were formulated as follows:

$${DK}_{i} = \{ \begin{matrix}1 & if {K}_{i} \leq {K}_{Th} \\ 0 & if {K}_{i} > {K}_{Th}\end{matrix} \qquad ( 3 )$$

Where DKᵢ refers to the decision for artifact detection based on Kᵢ, kurtosis for the i^{th} segment. ‘1’ represents clean data, whereas ‘0’ represents corrupted data. K_{Th} refers to the Kurtosis threshold.

$${DS}_{i} = \{ \begin{matrix}1 & if {SE}_{i} \geq {SE}_{Th} \\ 0 & if {SE}_{i} < {SE}_{Th}\end{matrix} \qquad ( 4 )$$

where DSᵢ refers to the decision for artifact detection based on SEᵢ, SE for the i^{th} segment. ‘1’ represents clean data whereas ‘0’ represents corrupted data. SE_{Th} refers to the SE threshold.

The fusion of kurtosis and SE metrics with their substantially optimal threshold values for the artifact detection was further consider and the sensitivity and specificity for the fusion of these two metrics was quantified. The decision rule for the detection of artifacts using a fusion of kurtosis and SE is:

$${FD}_{i} = \{ \begin{matrix}1 & if {DK}_{i} + {DS}_{i} = 2 \\ 0 & if {DK}_{i} + {DS}_{i} \neq 2\end{matrix} \qquad ( 5 )$$

Where FDᵢ refers to the fusion decision for artifact detection based on both DKᵢ and DSᵢ for the i^{th} segment. ‘1’ represents clean data whereas ‘0’ represents corrupted data.

### Bi-Spectrum Coupling

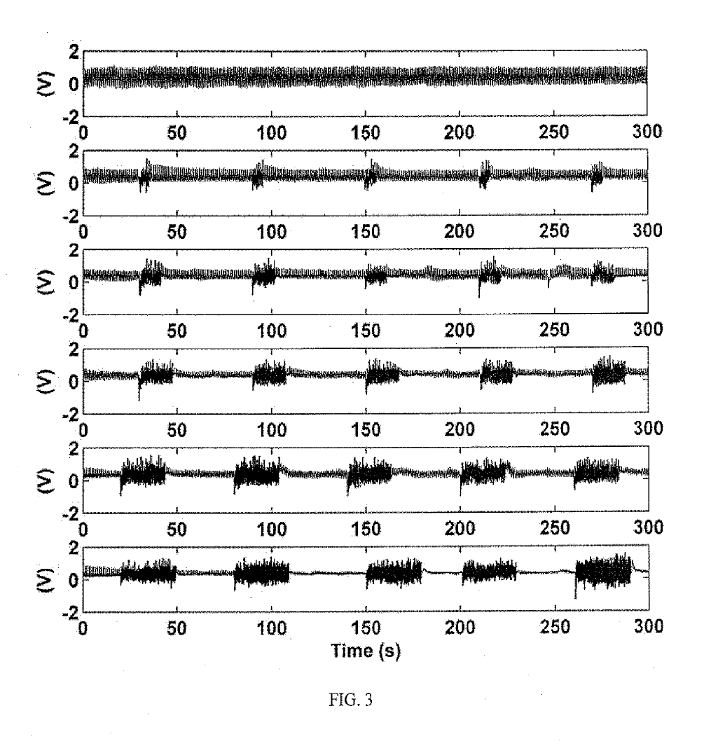

Protocol for bi-spectrum coupling measurements. In laboratory-controlled settings, PPG signals were acquired from a reflection type finger PPG transducer (TSD200, 860 nm) at 100 Hz in five healthy volunteers under upright sitting posture with and without motion artifacts, induced by left-right movements for predetermined time intervals that specified the presence of noise from 10 to 50% with respect to the total duration each PPG segment. A representative PPG data that illustrates the induced left-right movement for 10-50% of noise within each min of data length (FIG. 3).

BWS Technique:

The BWS method is a combination of bispectral estimation followed by testing the significance of QPC against surrogate data realizations, The BWS approach, is disclosed in K. L. Siu, J. M. Ahn, K. Ju, M. Lee, K. Shin, and K. H. Chon, “Statistical approach to quantify the presence of phase coupling using the bispectrum,” IEEE Trans Biomed Eng, vol. 55, pp. 1512-20, May 200, which is enclosed as Appendix I in U.S. Provisional Application Ser. No. 61/392,292 and in U.S. Provisional Application Ser. No. 61/434,862, all of which are incorporated by reference herein in their entirety for all purposes. The direct method of calculating the bispectrum of a signal is to take the average of triple products of the Fourier Transform over K segments:

$$BS ( {f}_{1} , {f}_{2} ) = \frac{1}{k} {\sum }_{k = 1}^{k} {X}_{k} ( {f}_{1} ) {X}_{k} ( {f}_{2} ) {X}_{k}^{*} ( {f}_{1} + {f}_{2} )$$

Realizations of 50 surrogate bispectral data from the original PPG data were generated. Any bispectral peaks estimated from original PPG data that are above the 95% statistical threshold value (mean±2*SD) of surrogate bispectra are considered to have significant QPC.

The presence or absence of QPC between the HR and its first harmonic, and its coupling strength has been evaluated for each 1 min PPG segment.

Results:

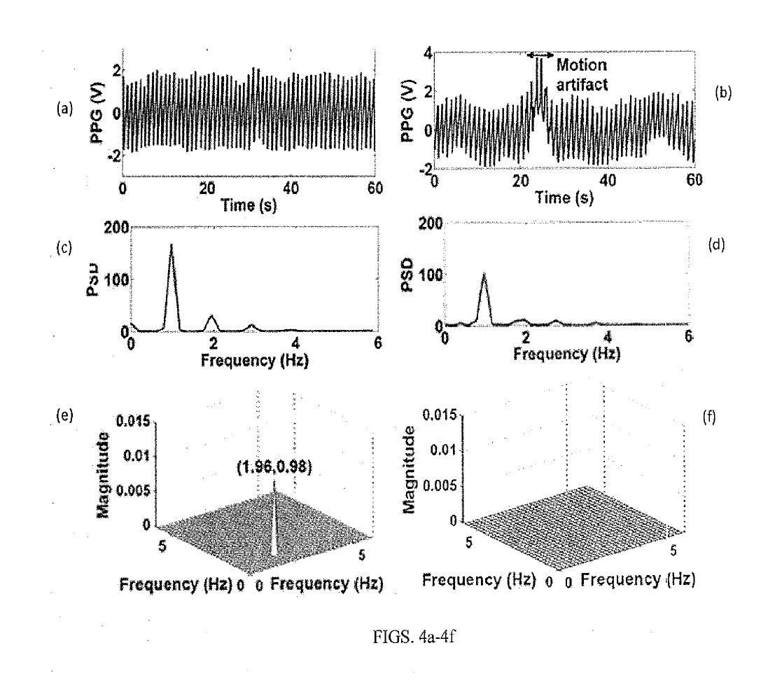

FIG. 4 shows the presence of phase coupling at the frequencies associated with HR and its first harmonic in noise-free PPG signal (3^{rd} raw, left panel), meanwhile the phase coupling is absent with the PPG signal corrupted with motion artifacts induced by left-right movement (3^{rd} row, right panel). Note that the power spectral density (PSD) suppresses phase relations; thus, it cannot be used for detection of phase coupling (2^{nd} row). When 750 PPG segments of 1 min data from 5 volunteers were analyzed, BWS method allows the detection of motion artifact with specificity of 94% and sensitivity of 86% (Table 1). For threshold value for QPC strength at 0.07, the sensitivity increased to 95% but with a decrease in specificity to 85% as a trade off.

TABLE 1
The sensitivity and specificity values obtained from
125 clean and 625 corrupted PPG segments with left-right movements.

| | | | | | | | Specificity |
|---|---|---|---|---|---|---|---|
| | Sensitivity (TP/(TP + FN) * 100) | | | | | | (TN/ |
| | 10% | 20% | 30% | 40% | 50% | Overall | (TN + FP) * |
| | noise | noise | noise | noise | noise | noise | 100) |
| No QPC_{Th} | 64.0 | 72.0 | 87.2 | 95.2 | 97.6 | 85.9 | 93.6 |
| QPC_{Th} = | 72.8 | 96.8 | 98.4 | 100 | 100 | 94.7 | 84.8 |
| 0.07 | | | | | | | |

QPC_{Th}: Threshold value for the strength of QPC.

From the false negatives, a weak phase coupled peak between HR and its first harmonic frequency was observed indicating the motion artifacts in these segments are not significant and do not disrupt the oscillatory dynamics of PPG signals. This is a scenario where these data should be preserved since they are usable rather than discarding them as unusable data.

In addition, the PPG segments are analyzed to obtain Shannon entropy, skewness and kurtosis which are shown to have higher magnitudes for corrupted data than clean. A decision fusion algorithm is formulated to fuse the metrics that include the phase coupling strength identified by BWS, Shannon entropy, skewness and kurtosis measures.

The decision rules for the detection of artifacts using QPC are formulated as follows:

$$DQPCi = \{ \begin{matrix}1 & if QPCi \geq QPCth \\ 0 & if QPCi \leq QPCth\end{matrix} \}$$

The decision rule for the detection of artifacts using a fusion of kurtosis, SE and QPC is:

$$FD = \{ \begin{matrix}1 & if DK + DSE + DQPC = 3 \\ 0 & if DK + DSE + DQPC \neq 3\end{matrix} \}$$

Where FDᵢ refers to the fusion decision for artifact detection based on both DKᵢ, DSᵢ, DQPCᵢ for the i^{th} segment. ‘1’ represents clean data whereas ‘0’ represents corrupted data.

F. Time-Frequency Spectral Analysis for the Assessment of Severity of Noise

In the second stage of our MNA algorithm, how severe the noise must be to affect the dynamics of the signal in the HR frequency range is assessed. Specifically, this second stage determines if some of the segments that were deemed to contain artifacts can be used for noninvasive blood loss detection, as these data may not be heavily contaminated.

This step first requires the computation of time-frequency analysis so that the amplitude modulations at each time point within the heart rate band can be obtained. This extracted amplitude modulation information is subsequently used to determine the state of usable data as detailed in the proceeding section. A time-frequency method known as the variable frequency complex demodulation method (VFCDM) to be described hereafter is used because it has been shown to provide one of the highest time-frequency resolutions.

VFCDM Analysis:

The development of the VFCDM algorithm has been previously disclosed in K. H. Chon, S. Dash, and K. Ju, “Estimation of respiratory rate from photoplethysmogram data using time-frequency spectral estimation,” IEEE Trans Biomed Eng, vol. 56, no. 8, pp. 2054-63, August, 2009 and in U.S. Patent Application Publication 20080287815, published on Nov. 20, 2008, corresponding to U.S. Patent Application No. A1/803,770, filed on May 16, 2007, both of which are incorporated by reference herein in their entirety for all purposes. Thus the VFCDM algorithm will be only briefly summarized hereinbelow.

Consider a sinusoidal signal x(t) to be a narrow band oscillation with a center frequency f₀, instantaneous amplitude A(t), phase φ(t), and the direct current component dc(t):

x(t)=dc(t)+A(t)cos(2πf₀t+φ(t)) (6)

For a given center frequency, the instantaneous amplitude information A(t) and phase information φ(t) can be extracted by multiplying (6) by e^{-f2πf}^{₀}^{t}, which results in the following:

$$z ( t ) = x ( t ) {e}^{- j2π {f}_{0} t} = dc ( t ) {e}^{- {j2πf}_{0} t} + ( \frac{A ( t )}{2} ) {e}^{jφ ( t )} + ( \frac{A ( t )}{2} ) {e}^{- j ( 4 π {f}_{0} t + φ ( t ) )} \qquad ( 7 )$$

A leftward shift by e^{-j2πf}^{₀}^{t} results in moving the center frequency f₀ to zero frequency in the spectrum of z(t). If z(t) in (7) is subjected to an ideal low-pass filter (LPF) with a cut-off frequency f_{c}<f₀, then the filtered signal zₗₚ(t) will contain only the components of interest and the following can be extracted:

$$\begin{matrix}{z}_{ip} ( t ) = \frac{A ( t )}{2} {e}^{jφ ( t )} & ( 8 ) \\ A ( t ) = 2 \vert {z}_{ip} ( t ) \vert & ( 9 ) \\ φ ( t ) = {tan}^{- 1} \frac{imag ( {z}_{ip} ( t ) )}{real ( {z}_{tip} ( t ) )} & ( 10 )\end{matrix}$$

The method can easily be extended to the variable frequency case, where the modulating frequency is expressed as ∫₀^{t}2πf(τ)dτ and the negative exponential term used for the demodulation is e^{-j∫}^{₀}^{^{t}}^{2πf(τ)dτ}. The instantaneous frequency can be obtained using the familiar differentiation of the phase information as follows:

$$f ( t ) = {f}_{0} + \frac{1}{2 π} \frac{d φ ( t )}{d ( t )} \qquad ( 11 )$$

Thus, the VFCDM method involves a two-step procedure. At first, the fixed frequency complex demodulation technique identifies the signal's dominant frequencies, shifts each dominant frequency to a center frequency, and applies a low-pass filter (LPF) to each of the center frequencies. The LPF has a cutoff frequency less than that of the original center frequency and is applied to each dominant frequency. This generates a series of band-limited signals. The instantaneous amplitude, phase and frequency information are obtained for each band-limited signal using the Hilbert transform and are combined to generate a time-frequency series (TFS). Finally, the second step of the VFCDM method is to select only the dominant frequencies and produce a high-resolution TFS.

Once the TFS of the PPG signal is obtained via the VFCDM method, the largest instantaneous amplitude at each time point within the HR band (HR±0.2 Hz) of the TFS of the VFCDM are extracted as the so-called AM_{HR} components of the PPG that reflect the time varying amplitude modulation (AM) of the HR frequency [18]. The initial and final 5s of the TFS were not considered for the AM_{HR} extraction because time frequency series have an inherent end effect that could produce false variability of the spectral power. The median value of the AM_{HR} components was evaluated for each corrupted PPG segment.

G. Determination of Usable PPG Segments Corrupted with Insignificant Artifacts:

The AM_{HR} median values were computed separately for clean PPG segments of each probe site for involuntary artifacts as well as for the voluntary artifact protocols as described above. The mean±2*SD of the AM_{HR} median population were determined as their respective 95% statistical limits for each clean PPG data set. If the AM_{HR} median value of the corrupted PPG segment lies within the statistical limits of the clean data, the respective corrupted PPG segment was considered as usable data; otherwise it was rejected. Thus, the model of our algorithm outlined in FIG. 1 has been designed to function in two separate stages for the detection and quantification of usable data among those that contain artifacts in PPG signals. Referring to FIG. 1, a segment of a signal (15, FIG. 1) from PPG is preprocessed (filtered) (55, FIG. 1), one or more indicators of volatility for the preprocessed segment are evaluated (60, FIG. 1) to determine from comparison of the value of the one or more indicators of volatility with a predetermined threshold whether or not noise/motion artifacts are not present. If noise/motion artifacts are not present, the segment is included in calculations quantities of interest (65, FIG. 1) and the method proceeds to another segment, if another segment is available. If noise/motion artifacts are present, a time-frequency spectrum analysis is performed for the preprocessed segment and a predetermined measure of the time-frequency spectrum analysis, AM_{HR}, is compared to a predetermined measure's threshold, the mean±2*Standard deviations (SD) of the AM_{HR} median population of a clean sample. If the predetermined measure is within limits determined by the predetermined measure's threshold, the segment is included in calculations quantities of interest and the method proceeds to another segment, if another segment is available). If the predetermined measure is not within the limits determined by the predetermined measure's threshold, the segment is discarded and the method proceeds to another segment, if another segment is available.

### Results

Our use of a high-order polynomial detrend for artifact detection is illustrated in FIG. 5. In a sample of a clean ear-PPG segment with moderate respiratory-induced baseline changes, the 1^{st}-order (FIG. 5a) or high-order detrend (FIG. 5b) did not alter its PDF, kurtosis and SE values. However, the 1^{st}-order detrend with another sample of a clean ear-PPG segment subjected to strong baseline drift (FIG. 5c) resulted in a long tail in its PDF. Thereby, the kurtosis has increased and the SE has decreased for this clean segment, relatively. On the other hand, the high-order (e.g., 32^{nd}-order) polynomial detrend on the same data (FIG. 5c) resulted in similar SE and kurtosis values as those shown in FIGS. 5a-5b. In a segment of corrupted PPG data subjected to a linear detrend (FIG. 5e), the low frequency trend masks the high-frequency artifacts. However, with the high-order polynomial detrend (FIG. 5f), the PDF, SE and kurtosis values are all drastically different from those of clean signals. Thus, the high-order polynomial detrend is an important component in enhancing the detection of artifacts. Note that our definition of clean data includes respiratory variations seen in FIGS. 5a and 5c since they are a part of physiological dynamics and are not artifacts. The artifact-corrupted data are considered to be those segments that contain sudden motion and noise as represented in FIGS. 5e and 5f.

Detection of Artifacts in Multi-Site PPG Data with Involuntary Motion/Noise Artifacts:

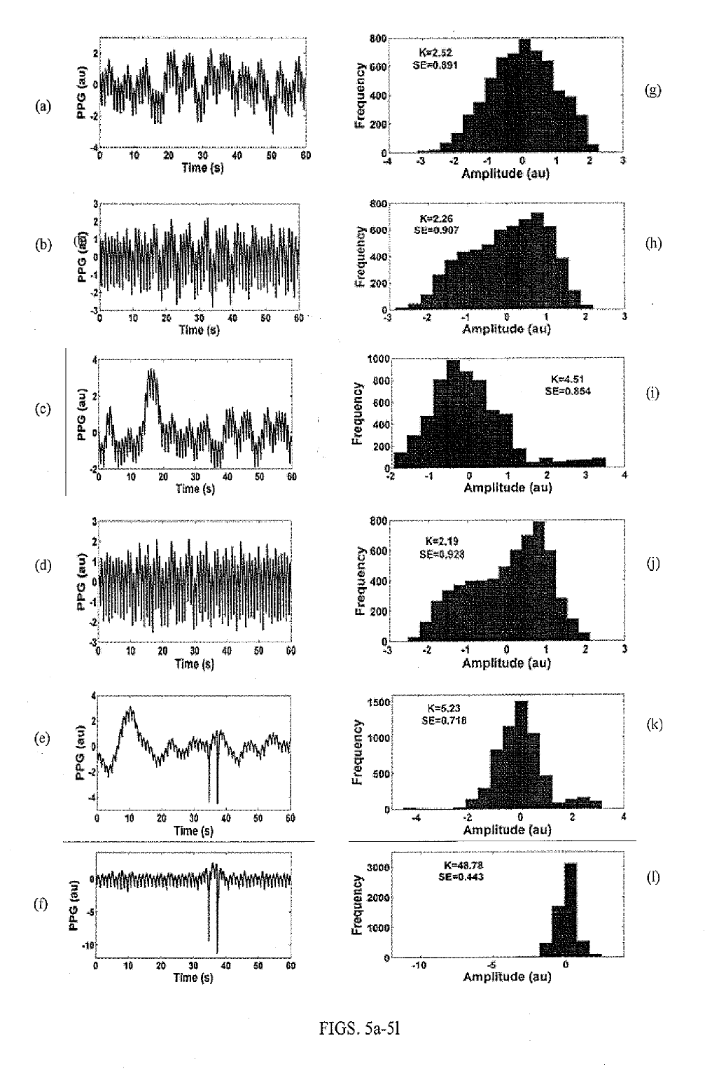

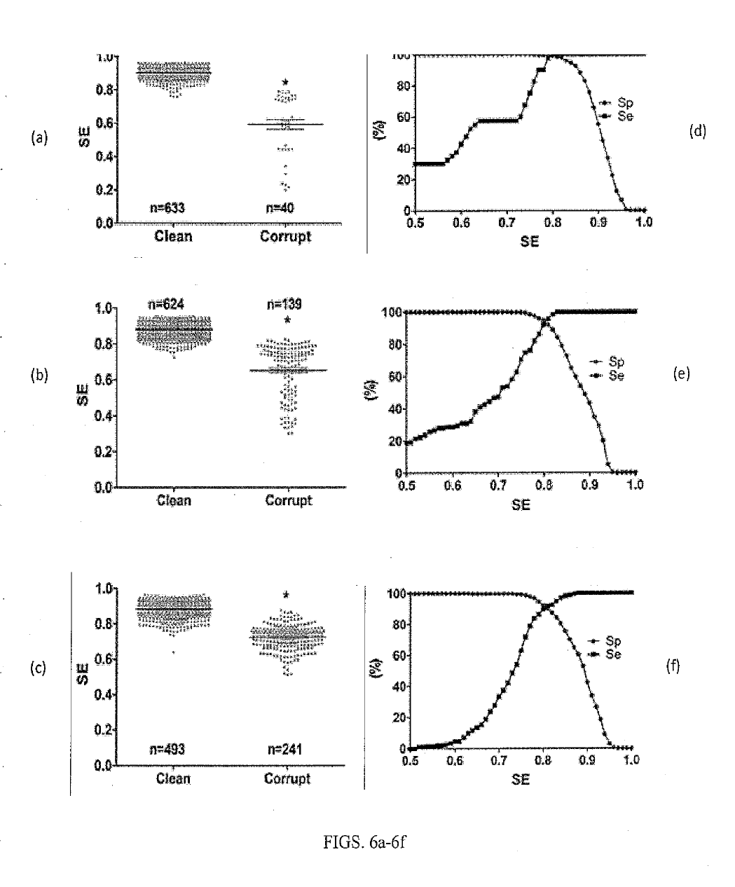

FIG. 6 shows the SE values (left panels) obtained for the clean vs. corrupted data segments of ear (1^{st} row), finger (2^{nd} row) and forehead (third row) PPG signals along with their respective specificity and sensitivity analyses (right panels). The corrupted PPG segments showed a significant (P<0.0001) decrease in SE value in all three probe sites as compared to their respective clean PPG segments. An optimal threshold value of SE (SE_{Th}) was found to be 0.8. Its specificity, sensitivity and accuracy values for the artifact detection in all three probe sites are given in Table 2. SE (SE_{Th}=0.8) offered an accuracy of 99.0%, 94.4% and 91.3% to classify clean vs. corrupted segments in ear, finger and forehead PPG signals, respectively.

TABLE 2
THE PERFORMANCE OF SE_{TH} = 0.8, K_{TH} = 3.5 AND FUSION OF THESE TWO
METRICS FOR THE DETECTION OF MOTION/NOISE artifacts IN MULTI-SITE
PPG SIGNALS RECORDED WITH INVOLUNTARY MOVEMENTS

| | | | | | | | Fusion detection with | | |
|---|---|---|---|---|---|---|---|---|---|
| | SE_{Th} = 0.8 | | | K_{Th} = 3.5 | | | SE_{Th} = 0.8 and K_{Th} = 3.5 | | |
| | Ear | Finger | Forehead | Ear | Finger | Forehead | Ear | Finger | Forehead |
| | PPG | PPG | PPG | PPG | PPG | PPG | PPG | PPG | PPG |
| Specificity (%) | 98.9 | 94.9 | 92.1 | 99.8 | 96.8 | 99.4 | 98.9 | 93.8 | 91.9 |
| Sensitivity (%) | 100 | 92.1 | 89.6 | 95 | 97.8 | 83.0 | 100 | 99.3 | 96.3 |
| Accuracy (%) | 99.0 | 94.4 | 91.3 | 99.6 | 97.0 | 94.0 | 99.0 | 94.8 | 93.3 |

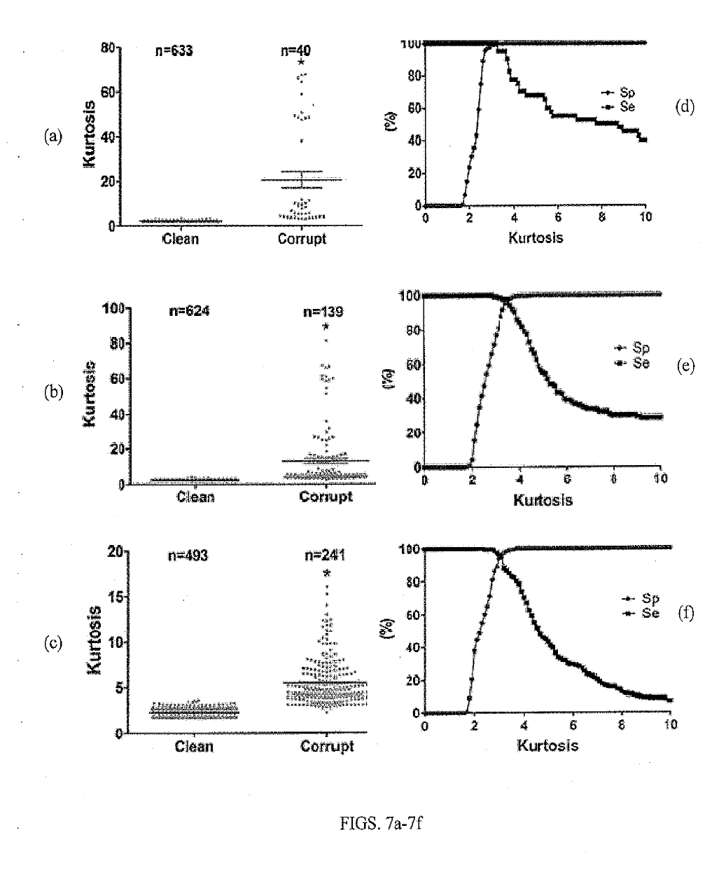

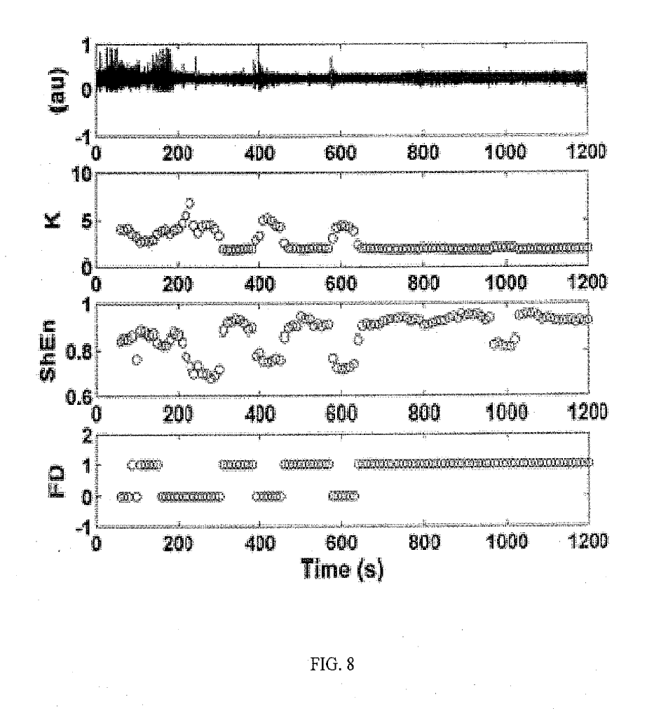

FIG. 7 depicts the kurtosis values (left panels) obtained for the clean vs. corrupted data segments of ear (1^{st} row), finger (2^{nd} row) and forehead (third row) PPG signals along with their respective specificity and sensitivity analysis (right panels). The corrupted PPG segments showed a significant (P<0.0001) increase in kurtosis values in all three probe sites as compared to their respective clean PPG segments. An optimal threshold value of kurtosis (K_{Th}) was found to be 3.5. Their specificity, sensitivity and accuracy values for the MNA detection in all three probe sites are given in Table 2. Kurtosis (K_{Th}=3.5) offered an accuracy of 99.6%, 97.0% and 94.0% to classify clean vs. corrupted segments in ear, finger and forehead PPG signals, respectively. Table 2 also provides the specificity and sensitivity values obtained for the three PPG sites using the fusion detection with S_{Th}=0.8 and K_{Th}=3.5. The fusion detection of SE and kurtosis metrics offered an accuracy of 99.0%, 94.8% and 93.3% for artifact detection for ear, finger and forehead PPG signals, respectively. The accurate and automatic detection of artifacts is illustrated in FIG. 8 with sample forehead PPG signals recorded in clinical settings with the fusion of SE and kurtosis measures.

Retrieval of Usable Data from Multi-Site PPG Data with Involuntary Motion/Noise Artifacts:

Whether data segments that are deemed to be contaminated with artifacts are usable was investigated by applying the AM_{HR} median significance bounds (mean±2*SD). The statistical significance limits of AM_{HR} median values are (1.05-1.42), (0.90-1.35) and (1.06-1.35) for artifact-free ear, finger and forehead PPG signals, respectively. Thus, if a data segment was deemed to be contaminated with artifacts, and if its AM_{HR} median values fell within these statistical significance limits, it is classified as a usable segment. It was found that the measurements from the forehead PPG sensor contained the most artifacts followed by finger and ear. For forehead, finger and ear, artifacts were present in 32.8%, 18.2% and 0.06% of the analyzed data segments, respectively. The percentage of usable data segments retrieved from the corrupted PPG segments using the AM_{HR} median significance limits were lowest for ear (12.5%) followed by finger (33.1%) and forehead (44.4%) PPG signals.

Detection of Artifacts in Finger-PPG Data with Voluntary Motion/Noise Artifacts:

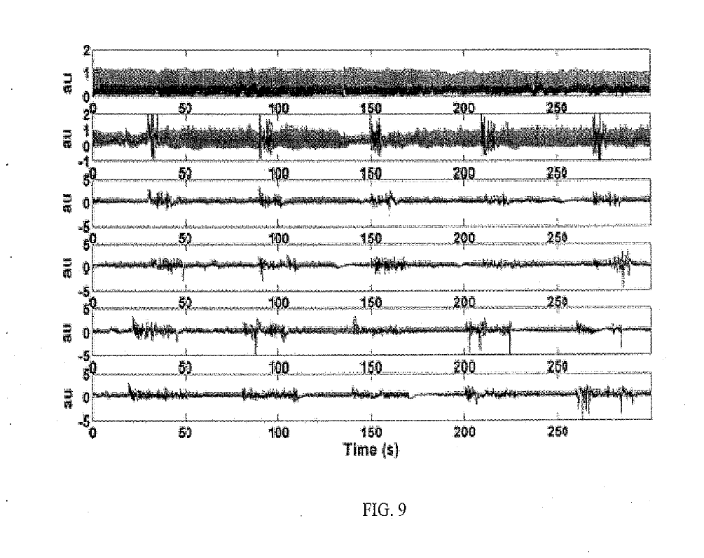

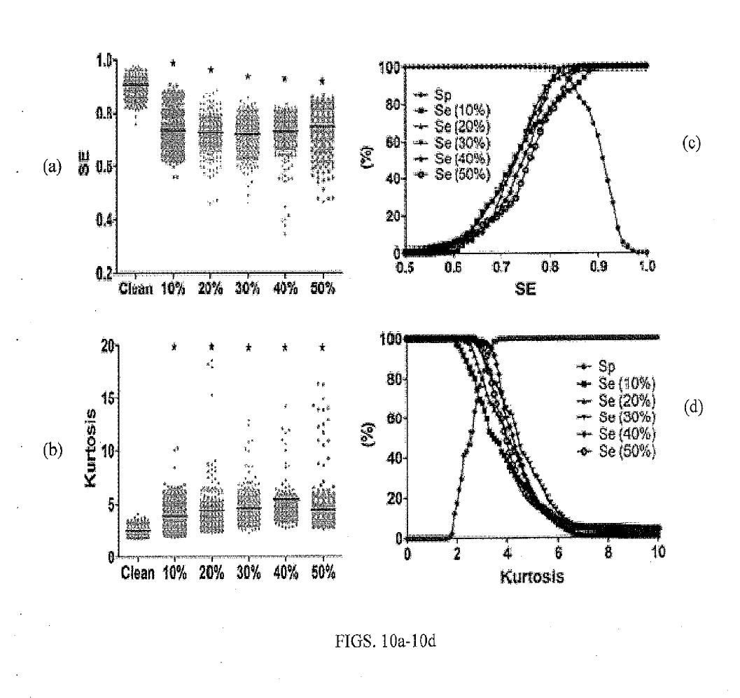

A representative clean finger-PPG data segment (1^{st} row) and voluntary artifact data segments (2^{nd}-6^{th} rows) are shown in FIG. 9 in which the controlled left-right movements were induced for 10% to 50% of each 1 minute PPG segment. The SE and kurtosis values obtained for clean (n=350 segments) and corrupted segments with varying levels (10-50%) of added artifacts (each with 350 segments) are shown in FIGS. 10a-b. Similar to the data with involuntary artifacts, a significant (P<0.0001) decrease in SE, and a significant increase (P<0.0001) in kurtosis were found for all levels of noise (10% to 50%) as compared to the clean PPG segments. Note that both SE and kurtosis values do not reflect the varying level of noise present in the PPG segments. FIGS. 10c-d show the specificity and sensitivity analysis for SE and kurtosis values. Table 3 gives the specificity and sensitivity values obtained for the optimal threshold values of SE (SE_{Th}=0.8) and kurtosis (K_{Th}=3.5) measures. The SE offered specificity of 99.4% and sensitivity of 85.0%, whereas kurtosis offered specificity of 98.6% and sensitivity of 72.6% for the finger-PPG signals induced with voluntary left-right movements. When kurtosis and SE measures were combined for the artifact detection with the threshold values of SE_{Th}=0.8 and K_{Th}=3.5, a specificity of 98.3% and sensitivity of 86.9% were obtained. It should be noted that the same substantially optimal threshold values for SE and kurtosis were obtained for both involuntary and voluntary artifacts. This can be a significant finding, if further independent testing on additional data results in similar SE and kurtosis threshold values. That is, diverse artifact sources (both voluntary and involuntary) resulted in the same optimal threshold values of SE and kurtosis, which suggests that the threshold values may be universal for this embodiment.

TABLE 3
THE PERFORMANCE OF SE_{TH} = 0.8, K_{TH} = 3.5 AND FUSION OF THESE TWO
METRICS FOR THE DETECTION OF MOTION/NOISE artifacts IN FINGER-PPG
SIGNALS RECORDED WITH VOLUNTARY MOVEMENTS

| | | Sensitivity (%) | | | | | Overall | |
|---|---|---|---|---|---|---|---|---|
| | Specificity | 10% | 20% | 30% | 40% | 50% | Sensitivity | Accuracy |
| | (%) | noise | noise | noise | noise | noise | (%) | (%) |
| SE_{Th} = 0.8 | 99.4 | 77.5 | 90.3 | 91.9 | 89.7 | 75.4 | 85.0 | 87.4 |
| K_{Th} = 3.5 | 98.6 | 49.4 | 72.9 | 77.5 | 91.4 | 71.7 | 72.6 | 77.0 |
| Fusion detection with | 98.3 | 77.2 | 90.0 | 91.6 | 95.7 | 79.7 | 86.9 | 88.8 |
| SE_{Th} = 0.8 and K_{Th} = 3.5 | | | | | | | | |

Retrieval of Usable Data from Finger PPG with Voluntary Motion/Noise Artifacts:

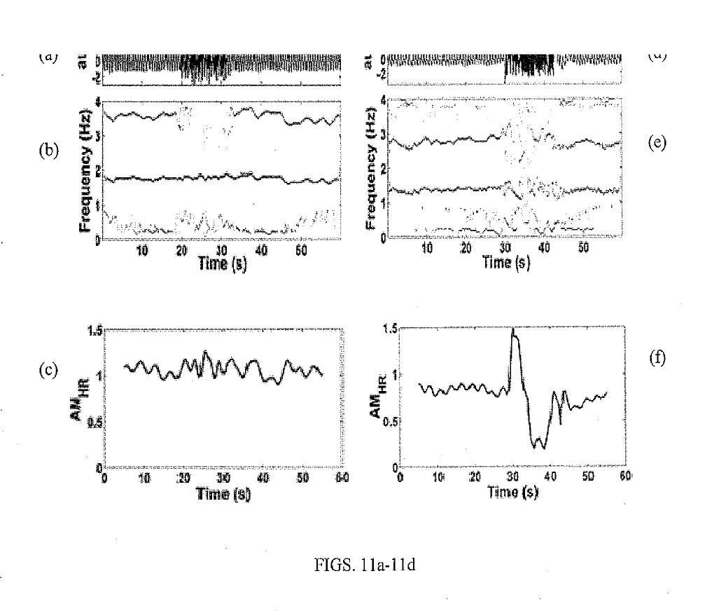

The statistical significance limits (mean±2*SD) of AM_{HR} median values for the clean finger PPG segments were found to be about (0.91-1.34), which is nearly identical to those for involuntary motion data. FIG. 11 shows representative usable (a) and not usable (d) corrupted PPG segments which were contaminated with 20% noise. The FIG. 11a PPG data segment is considered usable, since the HR dynamics of the PPG signal are not affected by noise as shown in the HR band (near 2 Hz) of the TFS (FIG. 11b) and the extracted AM_{HR} components (FIG. 11c) are not interrupted by sudden variations. Quantitatively, the AM_{HR} median value of this PPG segment was found to be about 1.06, which is well within the statistical limits of the clean signal's AM_{HR} median values. For a different artifact-contaminated data segment, shown in FIG. 11d, the HR dynamics of the PPG signal are severely affected by artifacts as shown in the HR band of the TFS (FIG. 11e between 30-42 seconds) and the extracted AM_{HR} components (FIG. 11f) exhibit sudden and large amplitude variations at 30-42 seconds. The AM_{HR} median value of this segment was found to be 0.80, which is not within the statistical limits of the clean signal's AM_{HR} median, and hence we considered this PPG segment (FIG. 811d) as not usable. Using this approach, the percentage of usable data segments retrieved from corrupted finger-PPG segments with voluntary movements using the AM_{HR} median significance limits were 85.8%, 64.0%, 29.8%, 19.7% and 8.9% for 10-50% noise levels, respectively. Note the graded decrease in the amount of usable data with increased artifacts, as expected. Thus, these results suggest that the method of these teachings, in this embodiment, is effective in retrieving usable data, which otherwise would have been discarded.

For the purposes of describing and defining the present teachings, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Elements and components described herein may be further divided into additional components or joined together to form fewer components for performing the same functions.

Each computer program may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable media include, for example, a floppy disk, a flexible disk, hard disk, magnetic tape, or any other magnetic medium, a CDROM, any other optical medium, any physical medium with patterns of holes, a RAM, a PROM, and EPROM, a FLASH-EPROM, any other memory chip or cartridge, all of which are non-transitory. As stated in the USPTO 2005 Interim Guidelines for Examination of Patent Applications for Patent Subject Matter Eligibility, 1300 Off. Gaz. Pat. Office 142 (Nov. 22, 2005), “On the other hand, from a technological standpoint, a signal encoded with functional descriptive material is similar to a computer-readable memory encoded with functional descriptive material, in that they both create a functional interrelationship with a computer. In other words, a computer is able to execute the encoded functions, regardless of whether the format is a disk or a signal.”

Although the teachings have been described with respect to various embodiments, it should be realized these teachings are also capable of a wide variety of further and other embodiments within the spirit and scope of the appended claims.

What is claimed is:

1. A method for detection and amelioration of the effects of motion/noise artifacts in physiological measurements, the method comprising the steps of:
a) preprocessing a segment of a signal from a physiological measurement;
b) obtaining a value of at least one indicator of volatility for the preprocessed segment;
c) including the segment in analyses of physiological measurements, if comparison of the value of the at least one indicator of volatility with a predetermined threshold indicates noise/motion artifacts are not present;
d) selecting another segment of the signal from the physiological measurement and proceeding to step (a), if the value of the at least one indicator of volatility is less than a predetermined threshold and another segment is available;
e) performing a time-frequency spectrum analysis for the preprocessed segment, if comparison of the value of the at least one indicator of volatility with the predetermined threshold indicates noise/motion artifacts are present;
f) comparing a predetermined measure of the time-frequency spectrum analysis to a predetermined measure's threshold;
g) including the segment in analyses of physiological measurements, if the predetermined measure is within limits determined by the predetermined measure's threshold;
h) discarding the segment, if the predetermined measure is not within the limits determined by the predetermined measure's threshold, and
i) selecting another segment of the signal from the physiological measurement and proceeding to step (a), if another segment is available;
j) repeat steps a) through i), if another segment is available.

2. The method of claim 1 wherein said at least one measure of volatility comprises kurtosis.

3. The method of claim 1 wherein said at least one measure of volatility comprises Shannon entropy.

4. The method of claim 1 wherein said at least one measure of volatility comprises kurtosis and Shannon entropy.

5. The method of claim 1 wherein said physiological measurement is a pulse oximeter waveform, referred to as a Photoplethysmogram (PPG).

6. The method of claim 5 wherein said at least one measure of volatility comprises a quadratic phase coupling between a fundamental heart rate frequency and a first harmonic of the fundamental heart rate frequency.

7. The method of claim 5 wherein said at least one measure of volatility comprises kurtosis.

8. The method of claim 7 wherein the predetermined threshold is determined using receiver operator characteristic (ROC) analysis.

9. The method of claim 5 wherein said at least one measure of volatility comprises Shannon entropy.

10. The method of claim 9 wherein the predetermined threshold is determined using receiver operator characteristic (ROC) analysis.

11. The method of claim 5 wherein said at least one measure of volatility comprises kurtosis and Shannon entropy.

12. The method of claim 11 wherein a first decision indicator is one if the kurtosis is less than a predetermined kurtosis threshold; wherein a second decision indicator for is one if the Shannon entropy is less than another predetermined kurtosis threshold; and wherein a joint decision indicator is 1 if the sum of the first decision indicator and the second decision indicator is equal to 2; the joint decision indicator having a value of 1 indicates that noise/motion artifacts are not present.

13. The method of claim 5 wherein said at least one measure of volatility comprises kurtosis and Shannon entropy and a quadratic phase coupling between a fundamental heart rate frequency and a first harmonic of the fundamental heart rate frequency.

14. The method of claim 5 wherein the time-frequency spectrum analysis is performed using a variable frequency complex demodulation method; and wherein the predetermined measure is a largest instantaneous amplitude within a frequency band centered on the heart rate.

15. A system for detection and amelioration of the effects of motion/noise artifacts in physiological measurements, the system comprising:
at least one processor; and
computer usable media having computer readable code embodied therein, the computer readable code causing said at least one processor to:
a) preprocess a segment of a signal from a physiological measurement;
b) obtain a value of at least one indicator of volatility for the preprocessed segment;
c) include the segment in analyses of physiological measurements, if comparison of the value of the at least one indicator of volatility with a predetermined threshold indicates noise/motion artifacts are not present;
d) select another segment of the signal from the physiological measurement and proceeding to step (a), if the value of the at least one indicator of volatility is less than a predetermined threshold and another segment is available;
e) perform a time-frequency spectrum analysis for the preprocessed segment, if comparison of the value of the at least one indicator of volatility with the predetermined threshold indicates noise/motion artifacts are present;
f) compare a predetermined measure of the time-frequency spectrum analysis to a predetermined measure's threshold;
g) include the segment in analyses of physiological measurements, if the predetermined measure is within limits determined by the predetermined measure's threshold;
h) discard the segment, if the predetermined measure is not within the limits determined by the predetermined measure's threshold, and
i) select another segment of the signal from the physiological measurement and proceeding to step (a), if another segment is available;
j) repeat steps a) to i), if another segment is available.

16. The system of claim 15 wherein said at least one measure of volatility comprises kurtosis.

17. The system of claim 15 wherein said at least one measure of volatility comprises Shannon entropy.

18. The system of claim 15 wherein said at least one measure of volatility comprises kurtosis and Shannon entropy.

19. The system of claim 15 wherein said physiological measurement is a pulse oximeter waveform, referred to as a Photoplethysmogram (PPG).

20. The system of claim 19 wherein said at least one measure of volatility comprises a quadratic phase coupling between a fundamental heart rate frequency and a first harmonic of the fundamental heart rate frequency.

21. The system of claim 19 wherein said at least one measure of volatility comprises kurtosis.

22. The method of claim 7 wherein the predetermined threshold is determined using receiver operator characteristic (ROC) analysis.

23. The system of claim 19 wherein said at least one measure of volatility comprises Shannon entropy.

24. The system of claim 23 wherein the predetermined threshold is determined using receiver operator characteristic (ROC) analysis.

25. The system of claim 19 wherein said at least one measure of volatility comprises kurtosis and Shannon entropy.

26. The system of claim 25 wherein a first decision indicator is one if the kurtosis is less than a predetermined kurtosis threshold; wherein a second decision indicator for is one if the Shannon entropy is less than another predetermined kurtosis threshold; and wherein a joint decision indicator is 1 if the sum of the first decision indicator and the second decision indicator is equal to 2; the joint decision indicator having a value of 1 indicates that noise/motion artifacts are not present.

27. The system of claim 19 wherein said at least one measure of volatility comprises kurtosis and Shannon entropy and a quadratic phase coupling between a fundamental heart rate frequency and a first harmonic of the fundamental heart rate frequency.

28. The system of claim 19 wherein the time-frequency spectrum analysis is performed using a variable frequency complex demodulation method; and wherein the predetermined measure is a largest instantaneous amplitude within a frequency band centered on the heart rate.

29. A computer program product comprising:
a non-transitory computer usable medium having computer readable code embodied therein for detection and amelioration of the effects of motion/noise artifacts in physiological measurements, the computer readable code causing at least one processor to:
a. preprocess a segment of a signal from a physiological measurement;
b. obtain a value of at least one indicator of volatility for the preprocessed segment;
c. include the segment in analyses of physiological measurements, if comparison of the value of the at least one indicator of volatility with a predetermined threshold indicates noise/motion artifacts are not present;
d. select another segment of the signal from the physiological measurement and proceeding to step (a), if the value of the at least one indicator of volatility is less than a predetermined threshold and another segment is available;
e. perform a time-frequency spectrum analysis for the preprocessed segment, if comparison of the value of the at least one indicator of volatility with the predetermined threshold indicates noise/motion artifacts are present;
f. compare a predetermined measure of the time-frequency spectrum analysis to a predetermined measure's threshold;
g. include the segment in analyses of physiological measurements, if the predetermined measure is within limits determined by the predetermined measure's threshold;
h. discard the segment, if the predetermined measure is not within the limits determined by the predetermined measure's threshold, and
i. select another segment of the signal from the physiological measurement and proceeding to step (a), if another segment is available;
j. repeat steps a) to i), if another segment is available.

30. The computer program product of claim 29 wherein said at least one measure of volatility comprises kurtosis.

31. The computer program product of claim 29 wherein said at least one measure of volatility comprises Shannon entropy.

32. The computer program product of claim 29 wherein said at least one measure of volatility comprises kurtosis and Shannon entropy.

33. The computer program product of claim 29 wherein said physiological measurement is a pulse oximeter waveform, referred to as a Photoplethysmogram (PPG).

34. The computer program product of claim 33 wherein said at least one measure of volatility comprises a quadratic phase coupling between a fundamental heart rate frequency and a first harmonic of the fundamental heart rate frequency.

35. The computer program product of claim 33 wherein the time-frequency spectrum analysis is performed using a variable frequency complex demodulation method; and wherein the predetermined measure is a largest instantaneous amplitude within a frequency band centered on the heart rate.
